(19) United States
(12) Patent Application Publication
(10) Pub. No.: US 2014/0166768 A1
(43) Pub. Date: Jun. 19, 2014

(54) AUTOMATED DEVICE FOR THE APPLICATION OF AGRICULTURAL MANAGEMENT MATERIALS

(71) Applicant: DOW AGROSCIENCES LLC, Indianapolis, IN (US)

(72) Inventors: Peter Scherer, Lebanon, IN (US); Luis Enrique Gomez, Carmel, IN (US); Kuide Quin, Westfield, IN (US)

(73) Assignee: DOW AGROSCIENCES LLC, Indianapolis, IN (US)

(21) Appl. No.: 13/803,970

(22) Filed: Mar. 14, 2013

Related U.S. Application Data
(60) Provisional application No. 61/739,605, filed on Dec. 19, 2012.

(51) Int. Cl. A01M 7/00

(52) U.S. Cl. CPC A01M 7/0032
USPC 239/1; 239/320

(57) ABSTRACT

An apparatus and method for applying an agricultural management material to targeted area. Exemplary agricultural management materials include viscous materials.

### RELATED APPLICATIONS

This application claims the benefit of U.S. Provisional Patent Application Ser. No. 61/739,605, filed Dec. 19, 2012, titled APPLICATION DEVICE DESIGNS FOR APPLYING AGRICULTURAL MANAGEMENT MATERIALS TO TARGETED SUBSTRATES, docket DAS-0285-01-US-E, the disclosure of which is expressly incorporated by reference herein.

This application is related to U.S. Provisional Patent Application Ser. No. 61/739,589, filed Dec. 19, 2012, titled AUTOMATED DEVICE FOR THE APPLICATION OF AGRICULTURAL MANAGEMENT MATERIALS, docket DAS-0284-01-US-E; U.S. Provisional Patent Application Ser. No. 61/739,581, filed Dec. 19, 2012, titled MECHANICAL APPLICATOR FOR AGRICULTURAL MANAGEMENT MATERIALS, docket DAS-0290-01-US-E; and U.S. Provisional Patent Application Ser. No. 61/739,599, filed Dec. 19, 2012, titled EQUIPMENT DESIGNS FOR APPLYING AGRICULTURAL MANAGEMENT MATERIALS, docket DAS-0289-01-US-E, the disclosures of which are expressly incorporated by reference herein.

### FIELD

The present invention relates to methods and apparatus for delivering an agricultural management material and in particular to methods and apparatus for delivering a viscous pest control material to targeted substrates including one or more of agricultural crops, plants, structures, and substrates in the proximity thereof.

### BACKGROUND

Viscous materials are used as specialized substrates for delivering pheromones and insecticides into agricultural settings such as orchards, groves, plantations, vineyards, and onto surrounding areas with the purpose of effecting pest control or management in the agricultural area. Traditional pest control materials are often diluted with water and sprayed under pressure on to the crops or other plant substrate. However, this is not an option for more viscous materials, materials that are not miscible in water, or materials that are intended to remain as discrete, localized deposits on the target substrate. Methods and apparatus for applying highly viscous materials, such as for pest control, that results in high levels of product deposition on the target plant, the controlled deposition of discrete or localized material on the target plant, or both, are desired.

### SUMMARY

In one exemplary embodiment, a method of applying a viscous agricultural management material to a targeted area is provided. The method comprises dispensing a quantity of the viscous agricultural management material from a container into a sample loading portion of a fluid conduit, the sample loading portion being bounded on one end by a first portion of a plunger positioned in the fluid conduit; directly contacting the quantity of viscous agricultural management material with the first portion of the plunger; moving the plunger from a first position to a second position due to an increased fluid pressure on a second portion of the plunger; and ejecting the quantity of viscous agricultural management material from the fluid conduit due to the movement of the plunger from the first position to the second position.

In another exemplary embodiment, a targeted material application device for a viscous agricultural management material is provided. The targeted material application device comprises a housing; a fluid conduit provided within the housing having a sample loading portion configured to receive a quantity of the viscous agricultural management material; a plunger provided within the housing and moveable between a first position and a second position, the plunger including a first portion received in the fluid conduit and bounding the sample loading portion of the fluid conduit and a second portion in fluid communication with a fluid chamber within the housing; and a bias member provided within the housing which biases the plunger towards the first position, wherein the plunger is moved towards the first position in response to a build-up of fluid in the fluid chamber which results in the quantity of viscous agricultural management material being ejected out of the fluid conduit.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 illustrates an exemplary embodiment of a targeted application device according to the present disclosure;

FIGS. 2A-2C illustrate a quantity of material being ejected from the targeted application device of FIG. 1;

FIG. 3 illustrates another exemplary embodiment of a targeted application device according to the present disclosure; and

FIG. 4 illustrates a perspective view of the targeted application device of FIG. 3 with the exterior surface of the housing shown transparently.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to the application of viscous materials onto agricultural or other plant substrates, it should be understood that the features disclosed herein may also have application to the application and delivery of other materials to other targets.

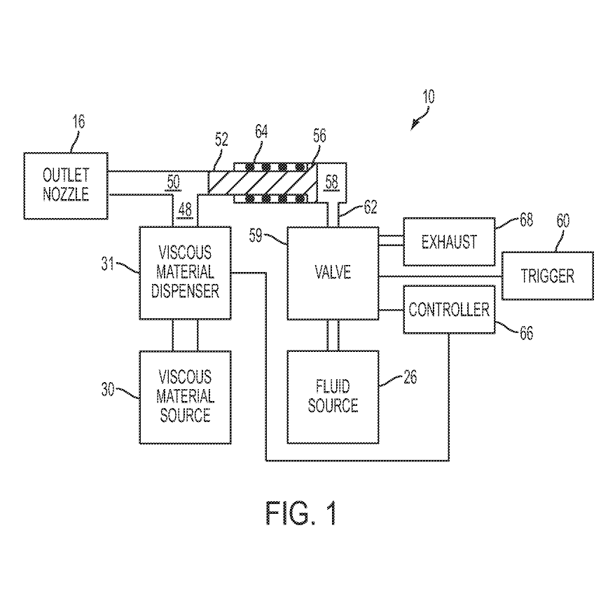

FIG. 1 illustrates an exemplary embodiment of a targeted application device 10. Material delivery device 10 includes a fluid conduit having a sample loading portion 50 in fluid communication with an outlet nozzle 16 of the fluid conduit for delivering a quantity of a viscous pest control material to a targeted area. The quantity of viscous material is forced from outlet nozzle 16 of targeted application device 10 by movement of a plunger 56 driven by a quantity of pressurized fluid, such as compressed air.

In one embodiment, targeted application device 10 applies an agricultural management material, such as a viscous material onto a targeted substrate. Exemplary agricultural management materials include pesticides, insecticides, pheromones, or other suitable viscous materials, onto a target. Suitable target substrates include trees, leaves, vines, stalks, and other suitable vegetation and plant substrates. Additional suitable target substrates include non-plant material in the area near the plant or crop, such as fence posts or other structures surrounding a field, orchard, plantation, or grove. In some embodiments, the targeted application device 10 reduces the amount of viscous material ending up in off-target locations like the ground, making a more efficient use of the viscous material.

In one embodiment, the present disclosure is directed to applying viscous agricultural management materials. Viscosity is a measure of the resistance of a fluid being deformed by either shear or tensile stress. Fluids with higher viscosity are observed as having a greater “thickness” or “internal friction,” while fluids with lower viscosity are observed as having a greater ease of movement or fluidity. In one embodiment, viscous materials include materials having a viscosity as low as about 1,000 cP, 2,000 cP, or 2,200 cP or as high as about 63,000cP, 65,000, or 75,000 cP, or within any range defined by between any pair of the foregoing values. Exemplary methods of measuring viscosity include using a Brookfield DVI viscometer, available from Brookfield Engineering Laboratories, Inc., Middleboro, Mass. Exemplary test conditions include measuring the viscosity at 21° C. using a Brookfield DVI viscometer with a #6 or #7 spindle and a spindle speed of 100 rpm.

Targeted application device 10 further includes a viscous material source 30 containing the viscous material to be applied by targeted application device 10 and a pressurized fluid source 26 supplying a burst of pressurized fluid to drive plunger 56 to eject the viscous material from targeted delivery device 10 through outlet nozzle 16. In one embodiment, pressurized fluid source 26 is a compressed gas source, such as an air compressor, a canister of pressurized air, nitrogen, or other suitable gas or vapor, or a pressurized supply of water or other suitable liquid, or mixtures thereof.

Viscous material source 30 is fluidly connected to sample loading portion 50 in targeted application device 10. In one exemplary embodiment, viscous material dispenser 31 dispenses viscous material into the sample loading portion 50. Exemplary viscous material dispensers include pumps and other suitable dispensers. In one exemplary, a controller 66 controls viscous material dispenser 31 to dispense a predetermined quantity of the viscous material into sample loading portion 50.

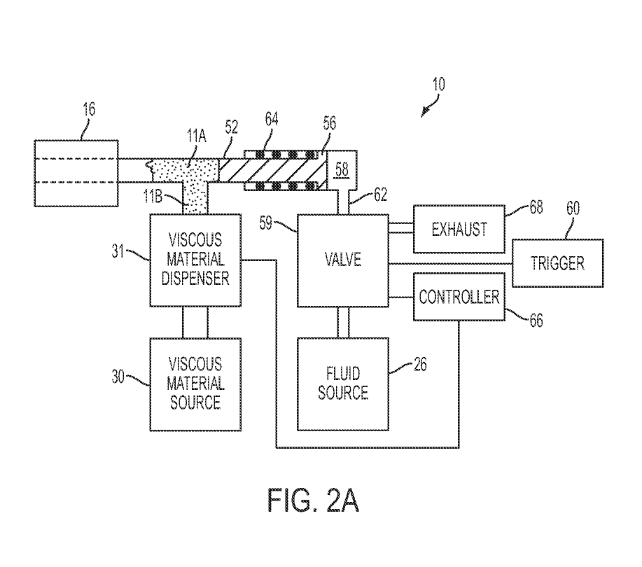

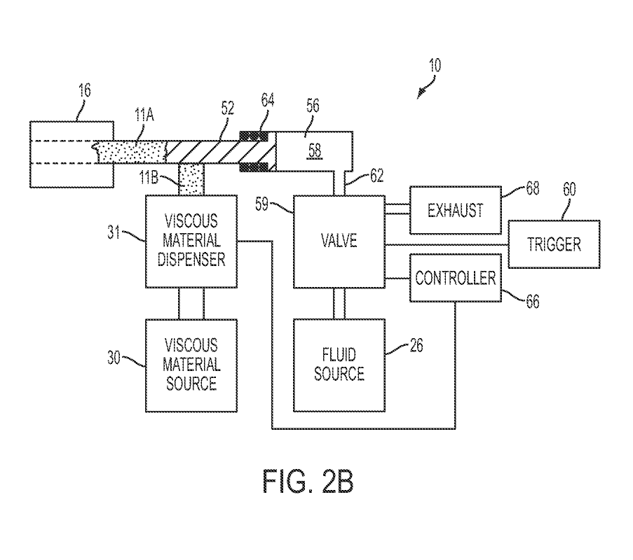

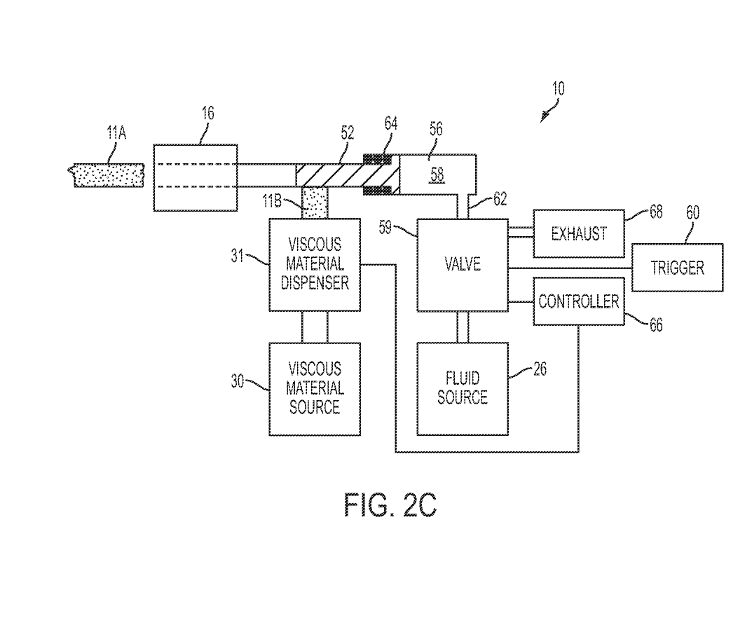

One end of sample loading portion 50 is bounded by plunger 56. Plunger 56 includes a portion 52 in direct contact with a sample in sample loading portion 50 and a portion in contact with a fluid chamber 58. Movement of plunger 56 towards the outlet nozzle 16 ejects a quantity of the viscous material in sample loading portion 50 out of targeted application device 10 through outlet nozzle 16 (see FIGS. 2A-2C).

Pressurized fluid source 26 is fluidly connected to fluid chamber 58. In one embodiment, controller 66 opens valve 59, allowing pressurized fluid into fluid chamber 58. In one exemplary embodiment, trigger 60 is coupled to valve 59 and depressing trigger 60 opens valve 59. When valve 59 is opened, pressurized fluid enters fluid chamber 58 and forces plunger 56 forward, ejecting viscous material from the sample loading portion 50 through outlet nozzle 16. Controller 66 closes valve 59 after a predetermined time has elapsed, and the pressurized fluid is vented through exhaust 68. Plunger 56 is then moved back to its original position by a force applied by spring 64.

Referring next to FIGS. 2A-2C, the exemplary targeted application device of FIG. 1 is illustrated expelling a quantity of a viscous material towards a targeted area. In the illustrated embodiment, the viscous material 11 includes a first portion 11A dispensed into the sample loading portion 50 and a second portion 11B remaining in the sample bore 48. As illustrated in FIG. 2A, when valve 59 is closed, viscous material dispenser 31 dispenses viscous material 11 such that the first portion 11A is positioned in the sample loading portion 50. Once a predetermined amount of viscous material 11 has been dispensed, viscous material dispenser 31 stops dispensing viscous material 11, leaving the second portion 11B in the material bore 48 fluidly coupled to the sample loading portion 50.

As illustrated in FIG. 2B, when valve 59 is opened, pressurized fluid, such as pressurized air, fills fluid chamber 58 and directly contacts the plunger 56. Plunger 56 is forced forward towards outlet nozzle 16. The plunger 56 separates first portion 11A from second portion 11B and pushes first portion 11A towards outlet nozzle 16. As illustrated in FIG. 2C, the first portion 11A is ejected, while the pressure in fluid chamber 58 is relieved by opening exhaust 68, allowing spring 64 to move plunger 56 back to its original location.

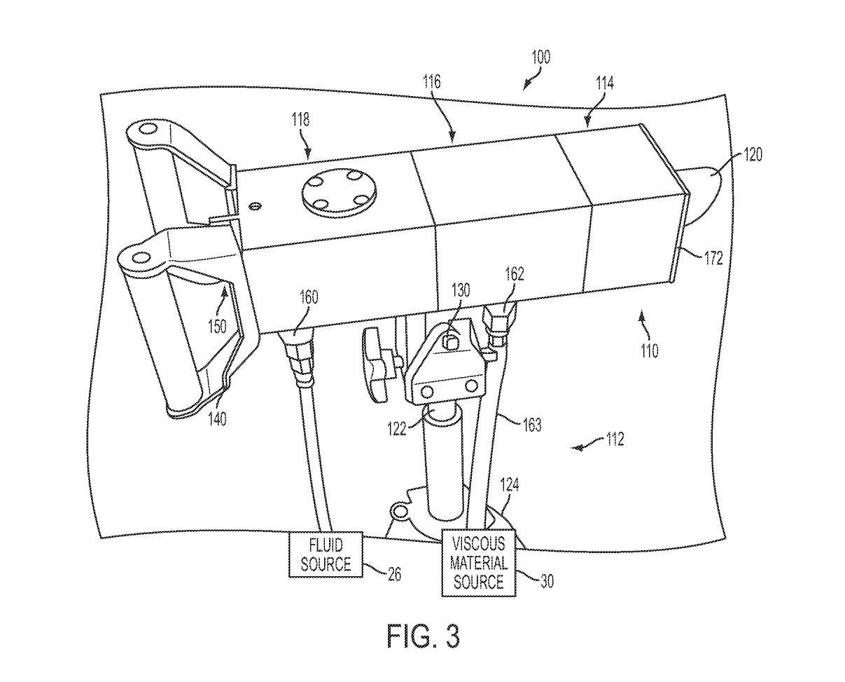

FIG. 3 illustrates another exemplary embodiment of a targeted application device 100 for applying a viscous material to a targeted area. Targeted application device 100 includes a housing 110 mounted on a stand 112. In an exemplary embodiment, housing 110 is comprised of three portions 114, 116, and 118 coupled together, where each of the three portions 114, 116, 118 is formed from aluminum. Targeted application device 100 further includes outlet nozzle 120 through which a viscous material is ejected towards the targeted area.

In the exemplary embodiment illustrated in FIG. 3, the housing 110 is coupled to shaft 122 rotatably received within the base 124 of stand 112, allowing horizontal aiming of targeted application device 100. Housing 110 is also pivotably attached to bolt 130 of stand 112, allowing vertical aiming of the targeted application device 100.

In one exemplary embodiment, a user aims the targeted application device 100 by grasping handle 140 and horizontally adjusting targeted application device 100 about base 124 and vertically adjusting targeted application device 100 about bolt 130 to position outlet nozzle 120 such that outlet nozzle 120 is oriented towards the target application area. A user then depresses or otherwise activates trigger mechanism 150 to eject a quantity of viscous material from the targeted application device 100.

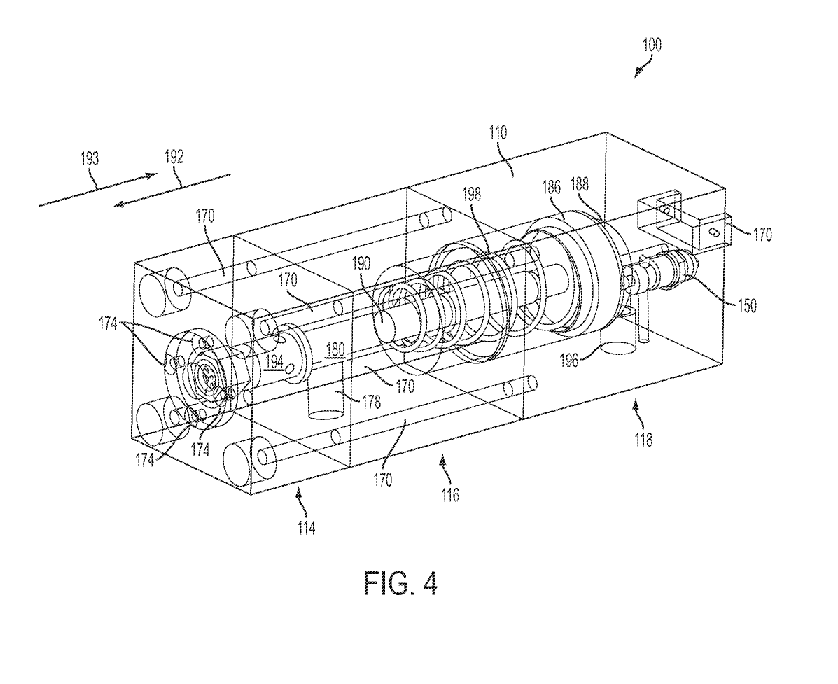

As illustrated in FIG. 3, targeted application device 100 is coupled to a pressurized fluid source 26 through an air coupling 160. In one exemplary embodiment, air coupling 160 is a quick-connect coupling to allow the targeted application device 100 to be disconnected from the pressurized fluid source 26. In an exemplary embodiment, pressurized fluid source 26 includes a flexible air hose attached to an air compressor. In one exemplary embodiment, trigger 150 opens a valve to communicate pressurized fluid to a fluid chamber 188 (see FIG. 4).

Also as illustrated in FIG. 3, targeted application device 100 is coupled to a viscous material source 30 through a second coupling 162. In one exemplary embodiment, viscous material source 30 includes a pressurized source or dispenser 31 (see FIG. 1) to supply the viscous material to the targeted application device 100. In one exemplary embodiment, the viscous material is pressurized by a pump before being provided to the targeted application device 100. In another exemplary embodiment, second coupling 162 is fluidly connected to a viscous material reservoir, such as viscous material source 30 that is pressurized to supply the viscous material to the targeted application device 100. In one exemplary embodiment, the viscous material is supplied through hose 163 directly to sample loading portion 180 (see FIG. 4). In another exemplary embodiment, the viscous material is supplied from the viscous material reservoir to a holding chamber (not shown) fluidly connected to the sample loading portion 180. In one embodiment, the fluid connection between the viscous material source 30 and sample loading portion 180 includes one or more valves (not shown) controlling the flow of viscous material into the sample loading portion 180, the holding chamber, or both.

Referring next to FIG. 4, a perspective view of the targeted application device 100 is shown with the exterior surface of housing 112 shown transparently.

As illustrated in FIG. 4, a handle attachment 170 is coupled to one end of housing 112. Handle 140 is coupled to handle attachment 170.

In the illustrated embodiment, housing 112 is comprised of a first portion 114, a second portion 116, and a third portion 118. First portion 114, second portion 116, and third portion 118 are coupled by fasteners (not shown) extending through threaded recesses 170 connecting portions 114, 116, and 118. Outlet nozzle 120 and front plate 172 are coupled to first portion 114 by a plurality of fasteners (not shown) to threaded recesses 174 in first portion 114.

In the illustrated embodiment, viscous material source 30 supplies a quantity of viscous material through material coupling 160 to material bore 178. Material bore 178 is coupled to sample loading portion 180. In one exemplary embodiment, the quantity of viscous material supplied to sample loading portion 180 is a predetermined amount based on the size of the sample loading portion 180. In one exemplary embodiment, the quantity of viscous material supplied to sample loading portion 180 is monitored through a sensor (not shown) such as a pressure sensor or a flow meter. In some embodiments, the sensor is in fluid communication with a holding chamber (not shown) fluidly connected to the sample loading portion 180. In another exemplary embodiment, viscous material from viscous material source 30 is supplied by a viscous material dispenser 31 (see FIG. 1) that includes a positive displacement pump, such as a peristaltic pump, that delivers a predetermined amount of viscous material to sample loading portion 180, a holding chamber, or both. Illustratively, sample loading portion 180 is a part of a cylindrical portion of a passageway that a plunger 186 reciprocates within. A front face 190 of plunger 186 bounds one end of sample loading portion 180. Movement of plunger 186 in direction 192 ejects the quantity of the viscous material in sample loading portion 180 through a delivery stabilizer 194 and out of targeted application device 100 through outlet nozzle 120 (see FIG. 3).

Plunger 186 is positioned adjacent a fluid chamber 188. Trigger mechanism 150 selectively opens a passageway 196 between pressurized fluid source 26 and fluid chamber 188 in response to an input from a user. In one exemplary embodiment, when trigger mechanism 150 is pressed, fluid chamber 188 quickly fills with pressurized air, forcing plunger 186 forward in direction 192 and compressing spring 198. Once released, trigger mechanism 150 then closes the passageway 196 between fluid chamber 188 and pressurized fluid source 26 and releases the air in fluid chamber 188 through an exhaust passageway (not shown). The air pressure on the backside of plunger 186 reduces, and plunger 186 is moved back to its original position in direction 193 due to the force applied by spring 190.

The forward motion of plunger 186 in direction 192 ejects a quantity of viscous material from sample loading portion 180, though delivery stabilizer 194, and out through outlet nozzle 120 towards the targeted area. Delivery stabilizer 194 serves to provide flight stability to the quantity of viscous material. In one exemplary embodiment, as the quantity of viscous material passes through delivery stabilizer 194, the viscous material is divided between a plurality of small orifices or tubes in delivery stabilizer 194, resulting in a more stabilized flight path.

While this invention has been described as relative to exemplary designs, the present invention may be further modified within the spirit and scope of this disclosure. Further, this application is intended to cover such departures from the present disclosure as come within known or customary practice in the art to which this invention pertains.

1. A method of applying a viscous agricultural management material to a targeted area, the method comprising:
dispensing a quantity of viscous agricultural management material from a container into a sample loading portion of a fluid conduit, the sample loading portion being bounded on one end by a first portion of a plunger positioned in the fluid conduit;
directly contacting the quantity of viscous agricultural management material with the first portion of the plunger;
moving the plunger from a first position to a second position due to an increased fluid pressure on a second portion of the plunger; and
ejecting the quantity of viscous agricultural management material from the fluid conduit due to the movement of the plunger from the first position to the second position.

2. The method of claim 1, wherein the step of directly contacting the quantity of viscous agricultural management material with the first portion of the plunger occurs during the dispensing step.

3. The method of claim 1, wherein the step of directly contacting the quantity of viscous agricultural management material with the first portion of the plunger occurs during the moving step.

4. The method of claim 1, further comprising the step of opening a valve positioned in a fluid connection between a pressurized source and a fluid chamber in communication with the second portion of the plunger and spaced apart from the sample loading portion, wherein opening the valve causes a pressurized fluid to contact the second portion of the plunger and move the plunger from the first position to the second position.

5. The method of claim 4, wherein the valve is opened in response to a signal from an at least one controller.

6. The method of claim 1, further comprising the step of dispensing the quantity of viscous agricultural management material from the container into the sample loading portion in response to a signal from an at least one controller.

7. The method of claim 1, further comprising the step of moving the plunger from the second position to the first position with a biased spring.

8. The method of claim 1, further comprising the step of stabilizing a trajectory of the quantity of viscous agricultural management material as it is ejected from the device with a delivery stabilizer.

9. A targeted material application device for a viscous agricultural management material comprising:
a housing;
a fluid conduit provided within the housing having a sample loading portion configured to receive a quantity of the viscous agricultural management material;
a plunger provided within the housing and moveable between a first position and a second position, the plunger including a first portion received in the fluid conduit and bounding the sample loading portion of the fluid conduit and a second portion in fluid communication with a fluid chamber within the housing;
a bias member provided within the housing which biases the plunger towards the first position, wherein the plunger is moved towards the first position in response to a build-up of fluid in the fluid chamber which results in the quantity of viscous agricultural management material being ejected out of the fluid conduit.

10. The device of claim 9, further comprising a valve selectively coupling a pressurized fluid source to the fluid chamber and configured such that when the valve is opened, pressurized fluid from the pressurized fluid source enters the fluid chamber and moves the plunger from the first position to the second position.

11. The device of claim 10, wherein the pressurized fluid source is a compressed air source.

12. The device of claim 9, further comprising a delivery stabilizer configured to stabilize a trajectory of the quantity of viscous agricultural management material as the agricultural management material is ejected from the device.

13. The device of claim 9, further comprising
a container containing a supply of the viscous agricultural management material, the container being in fluid communication with the sample loading portion of the fluid conduit;
a dispenser which provides the quantity of the viscous agricultural management material from the container to the sample loading portion of the fluid conduit;
a pressurized fluid source; and
a valve having a closed position in which a pressurized fluid from the pressurized fluid source is not in communication with the fluid chamber and an open position in which the pressurized fluid from the pressurized fluid source is in communication with the fluid chamber.

14. The device of claim 13, further comprising at least one controller, wherein the valve changes position in response to a fluid signal from the at least one controller.

15. The device of claim 14, wherein the dispenser provides the quantity of viscous agricultural management material from the container into the sample loading portion in response to a signal from the at least one controller.

16. The device of claim 13, further comprising at least one controller, wherein the dispenser provides the quantity of viscous agricultural management material from the container into the sample loading portion in response to a signal from the at least one controller.

17. The device of claim 9, wherein the viscous agricultural management material has a viscosity from about 2,000 cP to about 63,000 cP.

18. The device of claim 9, wherein the viscous agricultural management material has a viscosity from about 1,000 cP to about 75,000 cP.
